(19) United States
(12) Patent Application Publication
(10) Pub. No.: US 2026/0116140 A1
(43) Pub. Date: Apr. 30, 2026

(54) HVAC SYSTEM FOR REMOVAL OF MOISTURE OF AIR FLOWING THERETHROUGH

(71) Applicant: MAHLE International GmbH, Stuttgart (DE)

(72) Inventors: Edward WOLFE, Stuttgart (DE); Bailey REID, Stuttgart (DE); Austin MACEY, Stuttgart (DE); Debashis GHOSH, Stuttgart (DE)

(21) Appl. No.: 19/032,710

(22) Filed: Jan. 21, 2025

Related U.S. Application Data
(60) Provisional application No. 63/635,073, filed on Apr. 17, 2024.

(51) Int. Cl. B60H 1/00; F24F 8/10

(52) U.S. Cl. CPC B60H 1/00485; B60H 1/00021; F24F 8/10; B60H 2001/00085

(57) ABSTRACT

A heating and ventilation system that removes water vapor from recirculating air from a passenger compartment is provided. The system includes a housing that includes an air inlet and an air outlet, the air inlet comprising a first inlet that is aligned to receive air flowing from a passenger compartment of a vehicle that includes the housing, and a second inlet that is configured to receive air from outside of a vehicle. A housing supports a semipermeable membrane that is aligned with the first inlet such that air that flows through the first inlet flows through the semipermeable membrane before flowing to the air outlet, and wherein air flowing through the second inlet does not flow through the semipermeable membrane. A first port that is fluidly connected to the semipermeable membrane. The housing includes a valve disposed to control the air flowing therein.

### CROSS-REFERENCE TO RELATED APPLICATIONS

This application claims priority from U.S. Provisional Application No. 63/635,073, filed on Apr. 17, 2024, the entirety of which is hereby incorporated by reference herein.

### BACKGROUND OF THE INVENTION

This application relates to HVAC systems for vehicles or other machines that have passenger or other compartments that are desired to be environmentally controlled.

### SUMMARY OF THE INVENTION

A representative embodiment of the disclosure is provided. The embodiment includes a heating and ventilation system. The system includes a housing that includes an air inlet and an air outlet, the air inlet comprising a first inlet that is aligned to receive air flowing from a passenger compartment of a vehicle that includes the housing, and a second inlet that is configured to receive air from outside of a vehicle. The air outlet receives air from the first and second inlets and allows the air from the first and second inlets to flow to a fan. The housing supports a semipermeable membrane that is aligned with the first inlet such that air that flows through the first inlet flows through the semipermeable membrane before flowing to the air outlet, and wherein air flowing through the second inlet does not flow through the semipermeable membrane. A first port that is fluidly connected to the housing such that water vapor that flows into the first port from the housing flows from the semipermeable membrane. The housing further comprising a valve disposed within the housing that is positionable in a first position to allow air flow from the first air inlet through the semipermeable membrane to the air outlet and prevent flow from the second inlet to reach the air outlet, is positionable in a second position that allows air flow from the second inlet to reach the air outlet and prevents air flow from the first air inlet and the semipermeable membrane to reach the air outlet.

Other representative embodiments of the disclosure include the structure described by the Numbered Paragraphs at the end of this specification including all of the various combinations of elements within the various Numbered Paragraphs.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of an intake housing for a HVAC system for a vehicle.

FIG. 2 is another perspective view of the intake housing of FIG. 1.

FIG. 3 is a perspective cross sectional view of the intake housing of FIG. 1 about section A-A of FIG. 1 (without showing the schematic vacuum source depicted in FIG. 1).

FIG. 4 is a perspective view of another intake housing for an HVAC system for a vehicle.

FIG. 5 is another perspective view of the intake housing of FIG. 4.

FIG. 6 is a perspective view of yet another intake housing for an HVAC system for a vehicle.

FIG. 7 is a perspective cross-sectional view of the intake housing of FIG. 6 about section B-B of FIG. 6.

FIG. 8 is a bottom perspective view of the intake housing of FIG. 6.

FIG. 9 is a perspective view of yet another intake housing for a HVAC system with a housing similar to the housing of FIG. 1, with an external air intake to allow for a larger sized semipermeable membrane than possible with the size of the housing of FIG. 1.

### DETAILED DESCRIPTION OF THE INVENTION

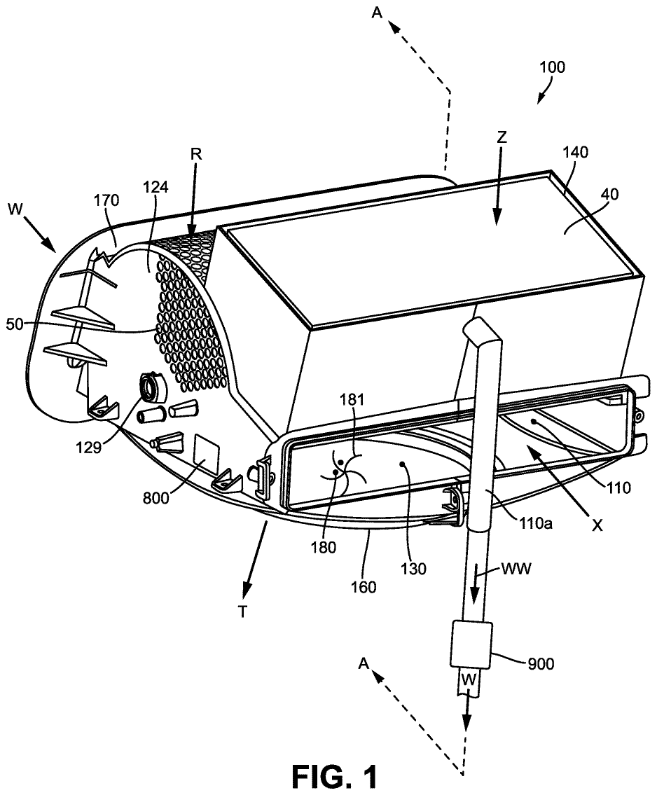

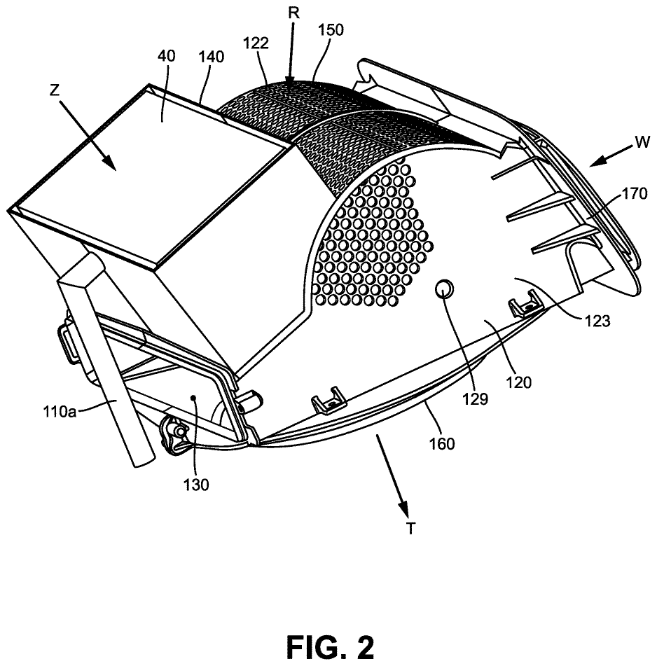

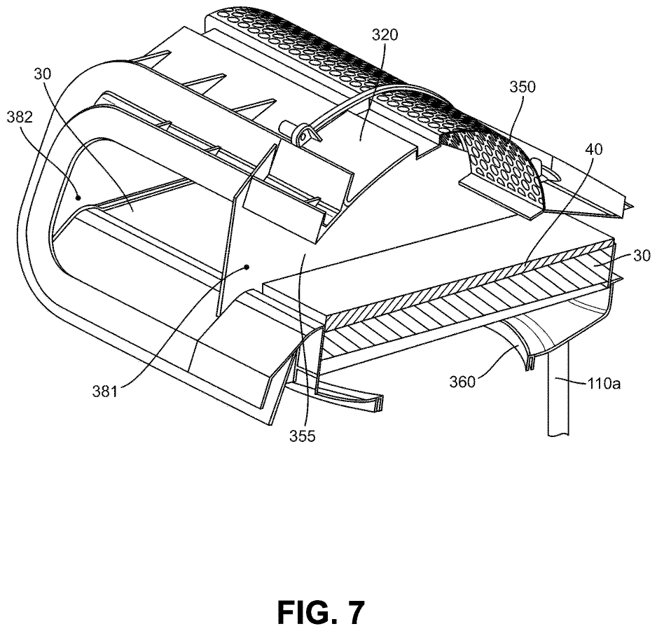

Turning now to FIGS. 1-9, an intake housing 100, 200, 300, 400 of a heating and ventilation system is provided. The heating and ventilation system is provided for a heating, ventilation, and air conditioning (HVAC) system that is particularly suited for a vehicle, and in some embodiments particularly suited for a vehicle that is solely powered by electricity (typically stored within one or more batteries within the vehicle), and in other embodiments a hybrid vehicle that includes an internal combustion engine and a battery and can desired by either the internal combustion engine or the battery as desired or as appropriate. The system may also be used for various types of vehicles such as passenger vehicles as well as other types of machines and heavy equipment that include a space (such as a passenger or operator space, or storage space) that is desired to have capability of heating or air conditioning of the space such as tractors, combines, excavators, cranes, trains, aircraft, boats, and the like. While the system can be successfully implemented for all of these types of vehicles and machines (and others that have one or more conditioned spaces) this specification will refer to the use of the system within a passenger vehicle for the sake of brevity.

The intake housing 100, 200, 300, 400 is configured to receive air that enters into the HVAC system, and specifically to be capable of receipt of air from outside of the vehicle that includes the HVAC system (“fresh air”) and air that is drawn in from the vehicle's passenger compartment (“recirculating air” or “recirc air”). The intake housing 100, 200, 300, 400 includes one or a plurality of valves 29 that control the source of air that flows into a fan plenum 180 and into the suction of a fan 181 (schematic)—the figures show a shaft 29 that is operated by an operator (not shown) with the valve being located within the intake housing 100. The fan plenum 180 may be within a fan housing (not shown) that can be attached to an outlet portion 160 (also 260, 360) of the intake housing 100, 200, 300, 400. The valves 29 can be in a position to allow flow of only fresh air, only recirculating air, or a combination of both fresh air and recirculating air, and prevent the other air flow. The term prevent is defined here to include preventing all flow that is not desired based upon the position of the valve 29 but to also cover a situation where a di minimus amount of non-desired flow is possible past the valve, such when the surfaces of the valve do not make complete surface to surface contact with the surfaces of the housing thereby not completely blocking undesired flow. The position of the valves 29 are controlled by an HVAC controller (800, schematic), with the position of the valve 29 being controlled based upon the user desired operation of the HVAC system or based upon instructions received from a vehicle controller. The valves 29 can be moved in direction M, N to the desired positions as controlled by the HVAC controller 800.

In conventional HVAC systems, heated air being supplied to the vehicle's passenger compartment is often provided exclusively from fresh air drawn into the fan, or with a vast majority of fresh air rather than with recirculating passenger compartment air. This is because the passenger compartment air typically has a much higher dew point and relative humidity (due to the presence of passengers that continuously give off water vapor into the passenger compartment air) than external air during cold weather operation of the vehicle-because the external air during cold weather has a very low relative humidity.

The usage of passenger compartment recirculated air by the HVAC system (as opposed to outside air) is beneficial particularly for electric vehicles or hybrid vehicles that are being currently operated by the battery. In electric vehicles or hybrid vehicles currently being powered by the battery, the operation of the HVAC and particularly the heat pump system to allow the heat pump heater (and electric heater when needed) to heat up the air flowing therepast requires a significant amount of electrical power, which decreases the vehicle battery's remaining charge, and therefore decreasing the distance that the vehicle can travel before stopping to recharge the vehicle's battery—or for hybrid vehicles the distance that the vehicle can travel without returning to use of the internal combustion engine for vehicle torque and to recharge the battery. The decrease of the HVAC load on the battery due to the relatively low amount of heat input needed when the HVAC housing receives passenger compartment air (which at steady state operation is substantially warmer than the outside air when the vehicle is running in a cold weather environment) causes the electrical power usage of the HVAC system (heat pump system, and electric heater if needed) to be minimized in order to maintain the passenger compartment at the desired temperature by the passengers.

In comparison, when the air used by the HVAC system is fresh air, the temperature of the fresh air during cold weather operation is much lower than the desired passenger compartment temperature, which therefore requires the heat pump heater (and when necessary the electric heater) to be operating at a very high level to transfer sufficient heat to the air that passes through the evaporator to increase the air temperature from the entry temperature (at or close to the temperature of the outside air) to the desired temperature for the passenger compartment. This high level of operation of the heat pump system consumes significant electrical power, which drains the battery relatively fast-thereby reducing the range of the vehicle (or the reduces the time that the a hybrid vehicle must return to internal combustion engine operation-which also decreases the range of the vehicle).

The intake housings 100, 200, 300 are provided and allow for only, or a higher percentage of, recirculation air to be used within an HVAC system for cold weather operations-without resulting in window fogging as typically occurs when using recirculating air in conventional HVAC systems.

Each of the intake housings 100, 200, 300, 400 are provided with a semipermeable membrane 40 that is provided therein and specifically in a position where all or a high percentage of recirculating air passes through the semipermeable membrane 40 before reaching the fan suction housing 180 and interacting with the fan 181. The intake housing 100, 200, 300, 400 is configured to receive air (either fresh air or recirculating air) and allow that air to flow to the fan 181. From the fan, the air flows (air flow T, schematic) through an evaporator and into the exit housing, where the air is guided into the heat pump heater (when the HVAC system is in heating or defrost mode) and is guided to the desired outlet via a plurality of valves therein. Air flows from the HVAC-depending upon the positions of the valves either to the defrost, the panel (i.e. the dashboard outlet louvers), or to the floor where it may flow into the first row, or flow to the second or third row of a vehicle.

The first intake housing 100 is depicted in FIGS. 1-3. The first intake housing 100 includes a first air inlet 150 and 140 that are both configured to receive recirculation air that flows thereto from the passenger compartment of the vehicle (not shown). The housing has a second inlet 170 that is configured to receive fresh air from outside the vehicle.

The first air inlet includes two different air inlets, one of which is an air inlet 150 that receives recirculation air allows that air to flow directly into an inner volume 110 of the housing. The air inlet 150 may comprise a plurality of holes 151 that are disposed through the wall of the housing. In the embodiment depicted in the figures, the holes are 151 are disposed multiple walls that form the housing (i.e. a curved center wall 122, and opposite right and left side walls 123, 124. The right and left walls 123, 124 may be planar and the center wall 122 extends between upper edges of the right and left walls. The curve of the center wall 122 may a continuous curve, such that the one or more valves 29 (that rotate about valve shafts 129) extend along the inner surface of the curved center wall 122 as they change positions as discussed herein.

The first air inlet also includes air inlet 140 that also is configured to receive recirculation air. The air inlet 140 receives a semipermeable membrane 40 therein, such that air that flows into the air inlet 140 flows through the semipermeable membrane 40 before reaching the inner volume 110 of the housing 20.

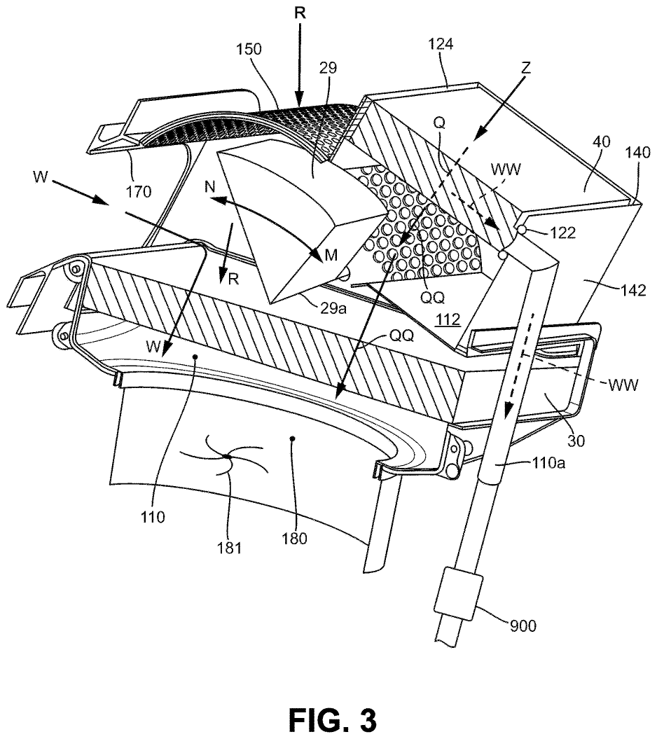

The semipermeable membrane 40 is configured to allow air that flows into the semipermeable membrane 40 to flow therethrough, with a substantial portion of the moisture (i.e. water vapor) that is entrained with the air blocked from flowing through the width of the semipermeable membrane and specifically prevented from flowing out of the semipermeable membrane 40. The semipermeable membrane 40 is connected to a first port 110a, such that water vapor that is blocked from flowing through the semipermeable membrane 40 flows or is directed into the first port 110a. In some embodiments, the first port 110a is connected to a vacuum source 900 (negative pressure source) that during operation draws a vacuum/suction within the first port 110a that is communicated to the semipermeable membrane 40 (and the sump 112 when provided, as discussed below), which directs the suction to the semipermeable membrane to “pull” the water vapor (flow WW, FIG. 3) within the semipermeable membrane 40 that is prevented or restricted from passing therethrough with the air out of the membrane and to the first port 110a. Operation of the vacuum source 900 urges water vapor within the semipermeable membrane to flow through the first port 110a and out of the housing 20 (schematically depicted as WW).

Due to the presence of the semipermeable membrane 40 the air that flows through and out of the semipermeable membrane 40 (as depicted schematically as Q, and QQ) includes a significantly lower percentage of water vapor than the air that flows into the housing 100 via the first inlet 150 (air flow schematically as R). The air (QQ) leaving the semipermeable membrane 40 has a lower amount of water vapor than the air Z that enters the semipermeable membrane.

In some embodiments, two flow paths (not shown) are provided to direct air to the two different first inlets (150 and 140). The HVAC controller 800 may control the recirculation air flow (through a valve, not shown) such that in some embodiments air flows only through the semipermeable membrane (and does not flow into the housing through the inlet 150, while in other embodiments, the HVAC controller 800 may control the recirculation air flow such that air does not flow through the semipermeable member (air inlet 140) and only flows through the inlet 150, or in some embodiments, the HVAC controller may operate such that air flows through both inlets 140, 150.

As can be understood, the air that flows through the semipermeable membrane 40 (Z, Q, QQ) experiences a significant resistance to flow therethrough, so that in, for example, circumstances when the HVAC system is operated as an air conditioner (and therefore the fresh air is at the same or a higher humidity as the air within the passenger compartment) there is no or a smaller need to remove water vapor from the air that flows through the HVAC system. In this case, the HVAC controller may direct all recirculation air to flow to the inlet 150 (and not through the inlet 140 and the semipermeable membrane 40) to eliminate the resistance to flow of the semipermeable membrane, which increases the air flow at the same fan speed, and prevents an even higher fan speed than is necessary without the semipermeable membrane 40 (thereby minimizing the fan noise/vibration heard/felt within the passenger compartment, and limiting the current needed to power the fan 181.

As can be understood, the operation of the fan 181 provides a negative pressure at the suction of the fan, which is communicated to the inlet 150, as well as to the semipermeable membrane 40, and the negative pressure at the outlet of the semipermeable membrane (compared to the positive pressure at the inlet of the semipermeable membrane 40) causes air to be “pulled” through the semipermeable membrane at a higher mass flow rate than it would if the fan 181 were not operating.

In circumstances when the fresh air is much colder than the passenger compartment air the HVAC controller 800 may manage the recirculation air flow into the housing 100 such that all recirculation air flows through the semipermeable membrane 40 so maximize the water vapor removable from the air that is directed into the passenger compartment from the HVAC system.

The first intake housing 100 additionally includes a second inlet 170 that is configured to receive air therein (W, schematic) that flows from outside the vehicle—i.e. fresh air. The fresh air W that flows into the inner volume 110 may flow to the fan plenum 180 (FIG. 3, schematic), based upon the position of the valve 29.

The first intake housing 100 may receive a filter 30 that is provided above the fan plenum 180 such that both the fresh air (W) and the recirculating air (R, Z) that is received within the housing passes through a filter 30 before passing to the fan 181. The air filter 30 may be replaceable, and may be received within a filter cavity 130, with the arrow X showing the direction that the filter 30 may be inserted into the filter cavity 130.

In some embodiments, the first port 110a is directly connected to the semipermeable membrane 40, such that water vapor that is removed from the air flowing therethrough (WW, schematic) extends directly to the first port 110a (in some embodiments due to the vacuum force generated by the vacuum source 900. The first port 110a may be connected to the semipermeable membrane with a seal 122 that extends between the semipermeable membrane 40 and the housing 142 to prevent air from entering the first port 110a from other than the semipermeable membrane 40. In some embodiments, a second seal 124 may be provided between the semipermeable membrane 40 and the housing 142 to prevent air from bypassing the semipermeable membrane 40 through the housing 142.

In other embodiments, the sump 112 is not provided and the first port 110a is directly connected to the semipermeable membrane 140. The first port 110a is connected to the semipermeable membrane 140 with a second seal 132 that prevents water vapor moving therethrough from leaving the semipermeable membrane other than through the first port 110a.

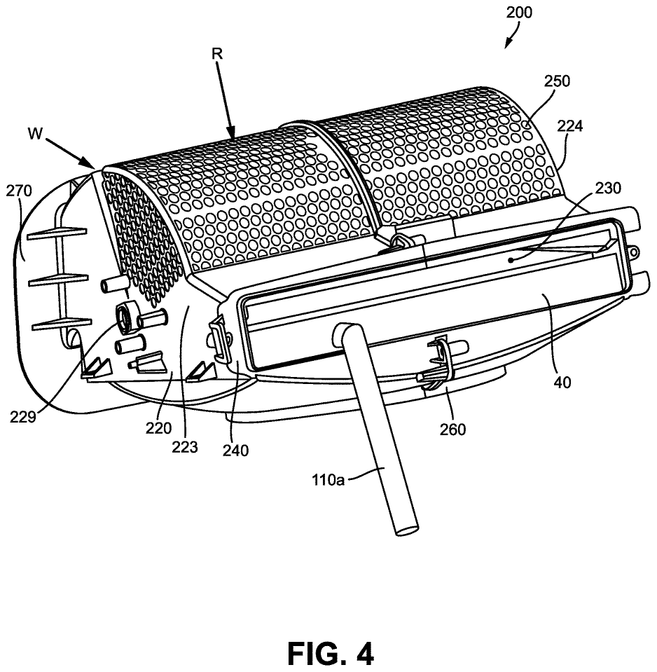

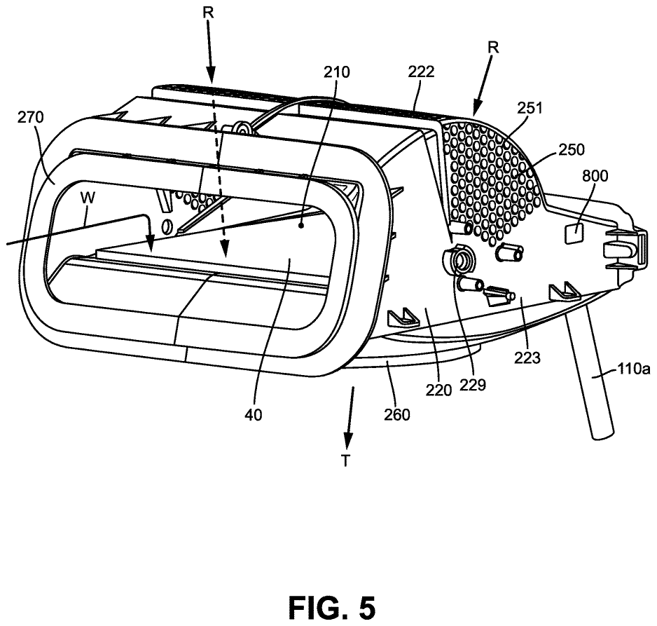

A second intake housing 200 is depicted in FIGS. 4-5. The second intake housing 200 includes a first air inlet 250 that is configured to receive recirculation air that flows thereto from the passenger compartment of the vehicle (not shown). The housing has a second inlet 270 that is configured to receive fresh air from outside the vehicle.

The first air allows recirculation air to flow into the internal volume 210 of the housing 200 (air flow R, schematic). The air inlet 250 may comprise a plurality of holes 251 that are disposed through the walls of the housing. In the embodiment depicted in the figures, the holes are 251 are disposed multiple walls that form the housing (i.e. a curved center wall 222, and opposite right and left side walls 223, 224. The right and left walls 223, 224 may be planar and the center wall 222 extends between upper edges of the right and left walls. The curve of the center wall 222 may a continuous curve, such that the one or more valves 29 (that rotate about valve shafts 129, now shown in FIGS. 4, 5 but similar to valve 29 depicted in FIG. 3)) extend along the inner surface of the curved center wall 222 as they change positions as discussed herein.

The internal volume 210 includes a semipermeable membrane 40 that is supposed such that recirculation air R that enters the internal volume passes through the semipermeable membrane 40.

The semipermeable membrane 40 is configured to allow air that flows into the semipermeable membrane 40 to flow therethrough, with a substantial portion of the moisture (i.e. water vapor) that is entrained with the air blocked from flowing through the width of the semipermeable membrane and specifically prevented from flowing out of the semipermeable membrane 40. The construction and operation of the semipermeable membrane 40 in this embodiment is similar to the construction and operation of the semipermeable membrane 40 discussed with respect to the housing 100 described above.

The semipermeable membrane 40 is connected to a first port 110a, such that water vapor that is blocked from flowing through the semipermeable membrane 40 flows or is directed into the first port 110a. In some embodiments, the first port 110a is connected to a vacuum source (negative pressure source, similar to vacuum source 900 depicted in FIG. 1 and described above) that during operation draws a vacuum/suction within the first port 110a that is communicated to the semipermeable membrane 40 (and the sump 112 when provided, as discussed below), which directs the suction to the semipermeable membrane to “pull” the water vapor (flow WW, FIG. 3) within the semipermeable membrane 40 that is prevented or restricted from passing therethrough with the air out of the membrane and to the first port 110a. Operation of the vacuum source 900 urges water vapor within the semipermeable membrane to flow through the first port 110a and out of the housing 20 (schematically depicted as WW).

Due to the presence of the semipermeable membrane 40 the air that flows through and out of the semipermeable membrane 40 (as depicted schematically as Q, and QQ in FIG. 3) includes a significantly lower percentage of water vapor than the air that flows into the housing 200 via the first inlet 250 (air flow schematically as R).

With the second intake housing 200, the semipermeable membrane 40 extends below the entire first air inlet 250, such that all recirc air (R) must flow through the semipermeable membrane 40 before flowing to the fan plenum (not shown, like the fan plenum 180 discussed above).

In some embodiments, the second intake housing 200 is configured to receive a filter, similar to the filter 30 discussed above. The filter can be removed and replaced as discussed above. In the embodiments the filter is received within a filter compartment 230 and can be installed or removed from the filter compartment 230.

In other embodiments, the intake housing 200 may be rearranged such that the filter compartment 230 is below the semipermeable membrane, and specifically such that recirc. air (R) that enters the intake housing 200 through the first inlet 150 encounters the semipermeable membrane 40 before encountering the filter.

The second intake housing 200 includes a second inlet 270 that is configured to allow fresh air to enter into the internal volume 210 of the housing (W, schematic). In this embodiment, the fresh air W also flows through the semipermeable membrane (and filter) and then into the fan housing (schematic air flow T, FIG. 5, the fan housing not shown but attached to the second intake housing 200 below the outlet portion 260).

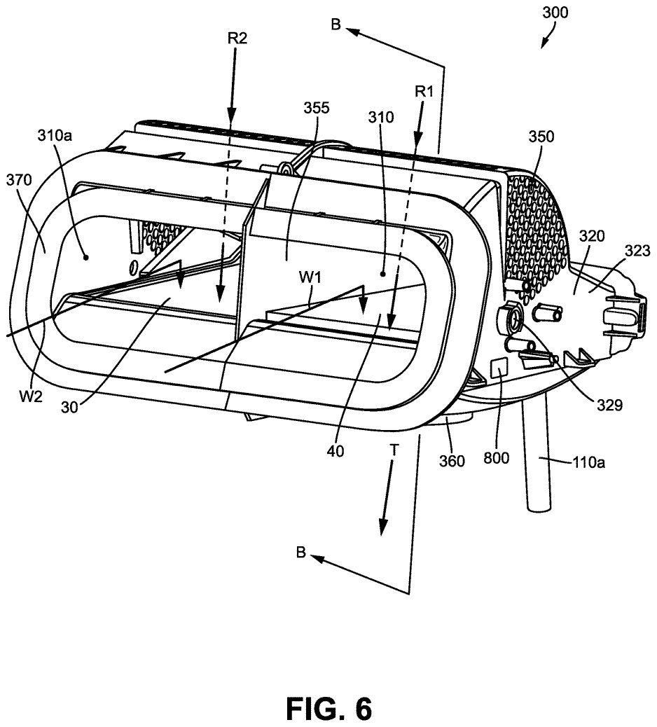

Turning now to FIGS. 6-8, the third intake housing 300 is provided. The third intake housing 300 includes a first air inlet 350 that is configured to receive recirculation air that flows thereto from the passenger compartment of the vehicle (not shown). The housing has a second inlet 370 that is configured to receive fresh air from outside the vehicle.

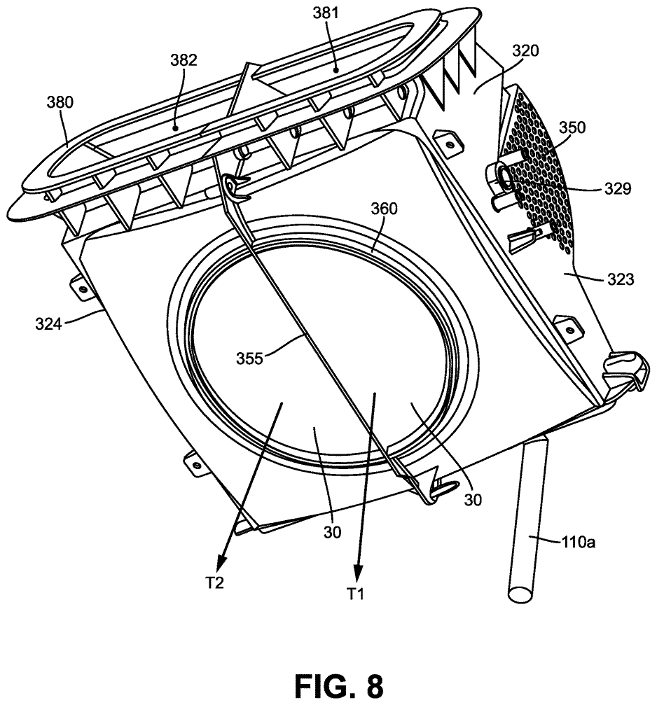

The third intake housing 300 allows recirculation air to flow into one of two separated internal volumes 310, 310a of the housing 300 (air flow R1 and R2, schematic). The air inlet 350 may comprise a plurality of holes 351 that are disposed through the walls of the housing. In the embodiment depicted in the figures, the holes are 351 are disposed multiple walls that form the housing (i.e. a curved center wall 322, and opposite right and left side walls 323, 324. The right and left walls 323, 324 may be planar and the center wall 322 extends between upper edges of the right and left walls. The curve of the center wall 322 may a continuous curve, such that the one or more valves 29 (that rotate about valve shafts 329, shown in FIGS. 6, 8) and similar to valve 29 depicted in FIG. 3)) extend along the inner surface of the curved center wall 322 as they change positions as discussed herein.

The third intake housing 300 includes a wall 355 that divides the internal volumes into two separated volumes 310, 310a as depicted in FIGS. 6-8. The position of the wall, causes the recirc air R1 that flows through the right wall 323 and the right side of the center wall 322 flows into the internal volume 310, and the recirc air R2 that flows through the left wall 324 and the left side of the center wall 322 flows into the second internal volume 310a. Similarly, the fresh air W1 that flows through the second inlet 370 on the right side of the wall 355 flows into the first internal volume 310, and the fresh air W2 that flows through the second inlet 370 on the left side of the wall 355 flows into the second internal volume 310a.

The first internal volume 310 includes a semipermeable membrane 40 that is supposed such that recirculation air R1 that enters the first internal volume passes through the semipermeable membrane 40 before passing through the outlet portion 360 and into the fan housing (not shown, similar to fan housing 180, schematic, FIG. 3.

The semipermeable membrane 40 is configured to allow air that flows into the semipermeable membrane 40 to flow therethrough, with a substantial portion of the moisture (i.e. water vapor) that is entrained with the air blocked from flowing through the width of the semipermeable membrane and specifically prevented from flowing out of the semipermeable membrane 40. The construction and operation of the semipermeable membrane 40 in this embodiment is similar to the construction and operation of the semipermeable membrane 40 discussed with respect to the housing 100 described above.

The semipermeable membrane 40 is connected to a first port 110a, such that water vapor that is blocked from flowing through the semipermeable membrane 40 flows or is directed into the first port 110a. In some embodiments, the first port 110a is connected to a vacuum source (negative pressure source, similar to vacuum source 900 depicted in FIG. 1 and described above) that during operation draws a vacuum/suction within the first port 110a that is communicated to the semipermeable membrane 40 (and the sump 112 when provided, as discussed below), which directs the suction to the semipermeable membrane to “pull” the water vapor (flow WW, FIG. 3) within the semipermeable membrane 40 that is prevented or restricted from passing therethrough with the air out of the membrane and to the first port 110a. Operation of the vacuum source 900 urges water vapor within the semipermeable membrane to flow through the first port 110a and out of the housing 20 (schematically depicted as WW).

Due to the presence of the semipermeable membrane 40 the air that flows through and out of the semipermeable membrane 40 (as depicted schematically as Q, and QQ in FIG. 3) includes a significantly lower percentage of water vapor than the air that flows into the housing 300 via the first inlet 350 (air flow schematically as R1).

The third housing 300 is configured such that the second internal volume 310a does not include a semipermeable membrane, as observed in FIG. 6 where the filter 30 is visible in the second internal volume 310, but the semipermeable membrane 40 (above the filter 30 as the air flows therethrough) is positioned above the filter in the first internal volume 310a. In other embodiments, the filter may be positioned above the semipermeable membrane 40, such that flow R1 encounters the filter before flowing into the semipermeable membrane 40 (similar to the housing 200 as depicted in FIGS. 4-5).

The third intake housing 300 includes a second inlet 370 that is configured to allow fresh air to enter into the first and second internal volumes 310, 310a of the housing (W1, W2, respectively, schematic). In this embodiment, the fresh air W1 into the first internal volume 310 also flows through the semipermeable membrane (and filter) and then into the fan housing (schematic air flow T1, FIG. 8, the fan housing not shown but attached to the second intake housing 300 below the outlet portion 360, similar to FIG. 3). The fresh air that flows into the second internal volume 310a (W2) does not flow through a semipermeable membrane as it flows to the outlet 360 and to the fan housing therebelow.

In some embodiments, separate inlet flow paths for recirc air may be provided, such that a first inlet flow path is positioned to establish flow R1 (which flows through the semipermeable membrane 40) and to establish the second flow R2 (that does not flow through the semipermeable membrane). These two flows may have a control valve to direct flow to the desired flow path, or both paths R1 and R2 as selected by the HVAC controller. For example, in situations where the vehicle is operated in warm air, and therefore the HVAC system is operated with air conditioning the HVAC controller may direct recirc air to only flow through path R2 to eliminate air needing to flow through the semipermeable membrane, which adds resistance to flow (thereby adding possible flow noise or needing higher fan speeds that need more electrical power to operate). In other embodiments, when the vehicle is operated in a cold outside environment, the HVAC system may be operated with the recirc air to only flow through path R1 such that all of the recirc air flows through the semipermeable membrane 40 to provide the water vapor removal benefit, thereby allowing all or more recirc air from the passenger compartment to be used within the passenger compartment but avoiding fogging as is known with convention systems that use recirc air for heating.

In some embodiments, the HVAC controller may also be configured to allow only fresh air flow W1 (such as in situations with very humid outside air during HVAC operation if fresh air is desired) or only fresh air flow W2 (such as in cold weather operation where the fresh air has a relatively low water vapor content) into the first intake housing (and the respective side 310, 310a).

In some embodiments, the first port 110a is directly connected to the semipermeable membrane 40, such that water vapor that is removed from the air flowing therethrough (WW, schematic, similar to FIG. 3 from the embodiment above) extends directly to the first port 110a (in some embodiments due to the vacuum force generated by the vacuum source 900). The first port 110a may be connected to the semipermeable membrane with a seal 122 that extends between the semipermeable membrane 40 and the housing 320 to prevent air from entering the first port 110a from other than the semipermeable membrane 40. In some embodiments, a second seal 124 may be provided between the semipermeable membrane 40 and the housing 142 to prevent air from bypassing the semipermeable membrane 40 through the housing 142.

In other embodiments, the sump 112 is not provided and the first port 110a is directly connected to the semipermeable membrane 140. The first port 110a is connected to the semipermeable membrane 140 with a second seal 132 that prevents water vapor moving therethrough from leaving the semipermeable membrane other than through the first port 110a.

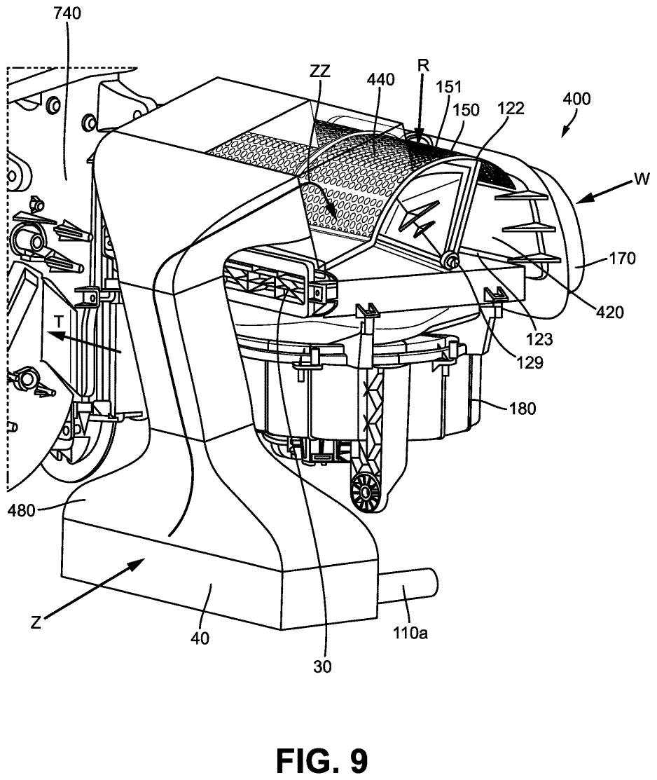

Turning now to FIG. 9, a fourth intake housing 400 is provided. The fourth intake housing 400 is similar to the first intake housing 100 and includes the same components as the first intake housing 100, with the differences between the fourth and the second intake housings discussed herein. For the sake of brevity, the same components on the first and fourth intake housings will be identified with the same element numbers.

The first air inlet includes two different air inlets, one of which is an air inlet 150 that receives recirculation air (R, schematic) allows that air to flow directly into an inner volume 110 of the housing. The air inlet 150 may comprise a plurality of holes 151 that are disposed through the wall of the housing. In the embodiment depicted in the figures, the holes are 151 are disposed multiple walls that form the housing (i.e. a curved center wall 122, and opposite right wall 123 and a left wall (not shown in FIG. 9, but similar to 124 depicted in FIG. 1). The right and left walls 123, 124 may be planar and the center wall 122 extends between upper edges of the right and left walls. The curve of the center wall 122 may a continuous curve, such that the one or more valves 29 (that rotate about valve shafts 129) extend along the inner surface of the curved center wall 122 as they change positions as discussed herein.

The first air inlet also includes air inlet 440 that also is configured to receive recirculation air (Z, schematic). The air inlet 440 is connected to an air duct 480 that extends away from the air inlet 440, to allow a larger surface area for receipt of the recirculation air (Z) than is available with the air inlet 440 due to the size of the housing 400, as limited by the space provided in the vehicle for the HVAC system.

The air duct 480 extends away from the housing 400 and includes a relatively large inlet area. The inlet area supports a semipermeable membrane 40, which is able to be substantially larger within the inlet area of the air duct 480 than the area provided within the air inlet 440 (which is similar or the same in size as the air inlet 140 of the housing 100). The larger surface area of the semipermeable membrane 40 within the inlet area of the air duct, allows for a higher percentage of water vapor to be removed from the intake air (Z, schematic) than in the embodiment of the housing 100 discussed above, which has a smaller semipermeable membrane 40 due to the relatively small air inlet 140 due to size constraints.

The semipermeable membrane 40 operates in a similar fashion as the semipermeable membrane operates with the housing embodiments (100, 200, 300) discussed above. The semipermeable membrane 40 is connected to a first port 110a, which may be connected to a vacuum source, as in the embodiments discussed above. The first port 110a may connect directly to the semipermeable membrane, or in other embodiments there may be sump (not shown but similar to sumps 112 with the embodiments discussed above) that allows for water vapor to collect, and condense that is pulled from the air flowing through the semipermeable membrane before being removed via the first port 110a.

FIG. 9 further depicts the fan housing 180, and schematically depicts the discharge air from the fan housing (T, schematic) flowing toward the evaporator the heat pump heater, and flow control valves within the second housing 740 of the HVAC system.

The term “about” is specifically defined herein to include a range that includes the reference value and plus or minus 5% of the reference value. The term “substantially the same” is when the item under comparison is within 5% of the aspect of the reference value of the item.

The computing elements or functions disclosed herein, such as the HVAC controller 800, may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Numbered Paragraphs:
Numbered Paragraph 1: A heating and ventilation system comprising:
a housing that includes an air inlet and an air outlet, the air inlet comprising a first inlet that is aligned to receive air flowing from a passenger compartment of a vehicle that includes the housing when the housing is installed within the vehicle, and a second inlet that is configured to receive air from outside of the vehicle;
wherein the air outlet receives air from the first and second inlets and allows the air from the first and second inlets to flow to a fan;
the housing supports a semipermeable membrane that is aligned with the first inlet such that air that flows through the first inlet flows through the semipermeable membrane before flowing to the air outlet, and wherein air flowing through the second inlet does not flow through the semipermeable membrane;
a first port that is fluidly connected to the housing such that water vapor that flows into the first port from the housing flows from the semipermeable membrane;
the housing further comprising a valve disposed within the housing that is positionable in a first position to allow air flow from the first air inlet through the semipermeable membrane to the air outlet and prevent flow from the second inlet to reach the air outlet, and is positionable in a second position that allows air flow from the second inlet to reach the air outlet and prevents air flow from the first air inlet and the semipermeable membrane to reach the air outlet.
Numbered Paragraph 2: The heat and ventilation system of Numbered Paragraph 1, wherein the valve is positionable in a third position that is between the first and second positions, wherein when in the third position, air from both the first air inlet and the second air inlet can reach the air outlet.
Numbered Paragraph 3: The heat and ventilation system of any one of Numbered Paragraphs 1 or 2, wherein the first port is configured to be connected to a component that during operation creates a suction within the first port, to urge fluid within the housing to flow out of the housing through the first port.
Numbered Paragraph 4: The heating and ventilation system of Numbered Paragraph 3, wherein during operation of the component the suction within the first port urges water vapor within the semipermeable membrane to flow out of the housing through the first port.
Numbered Paragraph 5: The heating and ventilation system of any one of Numbered Paragraphs 1-4, further comprising a seal that surrounds a perimeter of the semipermeable membrane, the seal establishes a tortuous path for air that flows through the first inlet to flow within the housing and bypassing the semipermeable membrane.
Numbered Paragraph 6: The heating and ventilation system of Numbered Paragraph 5, wherein the seal includes an aperture that the first port extends through.
Numbered Paragraph 7: The heating and ventilation system of Numbered Paragraph 5, wherein the seal extends from the first port.
Numbered Paragraph 8: The heating and ventilation system of any one of Numbered Paragraphs 1-7, wherein air flowing into and through the second inlet flows to the air outlet and does not flow through the semipermeable membrane.
Numbered Paragraph 9: The heating and ventilation system of any one of Numbered Paragraphs 1-8, further comprising a space within the housing for receiving a filter, wherein when a filter is installed within the space air flows through the filter before flowing into the air outlet.
Numbered Paragraph 10: The heating and ventilation system of any one of Numbered Paragraphs 1-9, further comprising a blower that takes suction from the housing, and specifically air that flows into the housing from one or both of the first and second inlets based the position of the valve.
Numbered Paragraph 11: The heating and ventilation system of any one of Numbered Paragraphs 1-10, further comprising a third inlet, the third inlet configured to receive air from outside of the vehicle, wherein the semipermeable membrane is aligned with the third inlet such that air that flows through the third inlet flows through the semipermeable membrane before flowing to the air outlet.
Numbered Paragraph 12: The heating and ventilation system of Numbered Paragraph 11, wherein the housing comprises a wall that divides the second inlet and the third inlet.
Numbered Paragraph 13: The heating and ventilation system of any one of Numbered Paragraphs 1-12, wherein the housing supports an air duct that establishes an air flow path to the first inlet, wherein the semipermeable membrane is disposed within the air duct, such that air that enters the air duct flows through the semipermeable membrane before reaching the first air inlet of the housing.
Numbered Paragraph 14: The heating and ventilation system of Numbered Paragraph 13, wherein the air duct includes a duct air inlet that is larger than the first air inlet, such that the semipermeable membrane may fill the duct air inlet and therefore be larger than a size of the semipermeable included within the first air inlet of the housing.
Numbered Paragraph 15: The heating and ventilation system of Numbered Paragraph 13, wherein a same amount of recirculation air that enters the duct air inlet flows past a larger volume of semipermeable membrane than the same amount of recirculation would flow past if the semipermeable membrane were within the first air inlet of the housing.

1. A heating and ventilation system comprising:
a housing that includes an air inlet and an air outlet, the air inlet comprising a first inlet that is aligned to receive air flowing from a passenger compartment of a vehicle that includes the housing when the housing is installed within the vehicle, and a second inlet that is configured to receive air from outside of the vehicle;
wherein the air outlet receives air from the first and second inlets and allows the air from the first and second inlets to flow to a fan;
the housing supports a semipermeable membrane that is aligned with the first inlet such that air that flows through the first inlet flows through the semipermeable membrane before flowing to the air outlet, and wherein air flowing through the second inlet does not flow through the semipermeable membrane;
a first port that is fluidly connected to the housing such that water vapor that flows into the first port from the housing flows from the semipermeable membrane;
the housing further comprising a valve disposed within the housing that is positionable in a first position to allow air flow from the first air inlet through the semipermeable membrane to the air outlet and prevent flow from the second inlet to reach the air outlet, and is positionable in a second position that allows air flow from the second inlet to reach the air outlet and prevents air flow from the first air inlet and the semipermeable membrane to reach the air outlet.

2. The heat and ventilation system of claim 1, wherein the valve is positionable in a third position that is between the first and second positions, wherein when in the third position, air from both the first air inlet and the second air inlet can reach the air outlet.

3. The heat and ventilation system of claim 1, wherein the first port is configured to be connected to a component that during operation creates a suction within the first port, to urge fluid within the housing to flow out of the housing through the first port.

4. The heating and ventilation system of claim 3, wherein during operation of the component the suction within the first port urges water vapor within the semipermeable membrane to flow out of the housing through the first port.

5. The heating and ventilation system of claim 1, further comprising a seal that surrounds a perimeter of the semipermeable membrane, the seal establishes a tortuous path for air that flows through the first inlet to flow within the housing and bypassing the semipermeable membrane.

6. The heating and ventilation system of claim 5, wherein the seal includes an aperture that the first port extends through.

7. The heating and ventilation system of claim 5, wherein the seal extends from the first port.

8. The heating and ventilation system of claim 1, wherein air flowing into and through the second inlet flows to the air outlet and does not flow through the semipermeable membrane.

9. The heating and ventilation system of claim 1, further comprising a space within the housing for receiving a filter, wherein when a filter is installed within the space air flows through the filter before flowing into the air outlet.

10. The heating and ventilation system of claim 1, further comprising a blower that takes suction from the housing, and specifically air that flows into the housing from one or both of the first and second inlets based the position of the valve.

11. The heating and ventilation system of claim 1, further comprising a third inlet, the third inlet configured to receive air from outside of the vehicle, wherein the semipermeable membrane is aligned with the third inlet such that air that flows through the third inlet flows through the semipermeable membrane before flowing to the air outlet.

12. The heating and ventilation system of claim 11, wherein the housing comprises a wall that divides the second inlet and the third inlet.

13. The heating and ventilation system of claim 1, wherein the housing supports an air duct that establishes an air flow path to the first inlet, wherein the semipermeable membrane is disposed within the air duct, such that air that enters the air duct flows through the semipermeable membrane before reaching the first air inlet of the housing.

14. The heating and ventilation system of claim 13, wherein the air duct includes a duct air inlet that is larger than the first air inlet, such that the semipermeable membrane may fill the duct air inlet and therefore be larger than a size of the semipermeable included within the first air inlet of the housing.

15. The heating and ventilation system of claim 14, wherein a same amount of recirculation air that enters the duct air inlet flows past a larger volume of semipermeable membrane than the same amount of recirculation would flow past if the semipermeable membrane were within the first air inlet of the housing.
